(19) United States
(12) Patent Application Publication
(10) Pub. No.: US 2025/0365153 A1
(43) Pub. Date: Nov. 27, 2025

(54) METHOD AND SYSTEM FOR CREATING PASSWORD USING DYNAMICALLY CHANGEABLE REGULAR EXPRESSION

(71) Applicants: LINE Plus Corporation, Seongnam-si (KR); LY CORPORATION, Tokyo (JP)

(72) Inventors: Prashant POL, Tokyo (JP); Vernon CHUO CHIAN KHYE, Tokyo (JP); Yeonha PARK, Seongnam-si (KR); Euiyub JUNG, Seongnam-si (KR); TaeJeong KIM, Seongnam-si (KR); Junichi TSURUKAWA, Tokyo (JP); Artem MIRONOV, Tokyo (JP)

(73) Assignees: LINE Plus Corporation, Seongnam-si (KR); LY CORPORATION, Tokyo (JP)

(21) Appl. No.: 19/213,430

(22) Filed: May 20, 2025

(30) Foreign Application Priority Data
May 23, 2024 (KR) 10-2024-0067227

(51) Int. Cl. H04L 9/32; H04L 9/08

(52) U.S. Cl. CPC H04L 9/3226; H04L 9/0861; H04L 9/3236

(57) ABSTRACT

A password creation method includes transmitting a password creation request from a user of a computer device to a server; receiving, from the server, a regular expression that is created at the server based on a password creation rule and user information in response to the password creation request; verifying validity of the password entered by the user based on the regular expression; and hashing the password of which the validity is verified and transmitting the hashed password to the server.

### CROSS-REFERENCE TO RELATED APPLICATION(S)

This U.S. non-provisional application claims the benefit of priority under 35 U.S.C. § 119 to Korean Patent Application No. 10-2024-0067227, filed May 23, 2024, the entire contents of which are incorporated herein by reference in their entirety.

### BACKGROUND

A web-based solution or service registers utilizes a user's ID and password to identify and authenticate the user. The user may enter a pre-registered ID and password to use the web-based solution or service.

Meanwhile, when the user desires to register an initial password or when the user desires to change the registered password to another password, the password needs to be created according to preset, or alternately given, rules. For example, in the art, rules for password creation are preset, or alternately given, for each web-based solution or service. The user needs to create and register a password in accordance with fixed rules of a web-based solution or service that the user desires to register the password.

### SUMMARY

Some example embodiments provide a method and system for creating a password using a dynamically changeable regular expression.

According to at least one example embodiment, there is provided a password creation method of a computer device including at least one processor, the password creation method including transmitting, by the at least one processor, a password creation request from a user of the computer device to a server; receiving, by the at least one processor from the server, a regular expression that is created at the server based on a password creation rule and user information in response to the password creation request; verifying, by the at least one processor, validity of the password entered by the user based on the regular expression; and hashing, by the at least one processor, the password of which the validity is verified and transmitting the hashed password to the server.

According to some example embodiments, the regular expression may include the password creation rule that is determined based on the user information or user activity in an application associated with the computer device.

According to come example embodiments, the password creation method may further include providing the user with information on the regular expression to induce the user to enter a new password in accordance with the password creation rule.

According to some example embodiments, the regular expression may be determined based on the user information, and the regular expression may be different from a regular expression created for another user.

According to some example embodiments, the regular expression may be differently created according to a change in the user information.

According to some example embodiments, at least a portion of the user information may include at least one of information that is not stored in the computer device, information that is not managed by a computer program, or information that is stored only in the server.

According to some example embodiments, the receiving of the regular expression from the server may include further receiving, from the server, at least one error message information that is created based on the password creation rule or the regular expression, and the verifying of the validity of the password may include outputting an error message based on the at least one error message information in response to the password entered by the user violating the regular expression.

According to some example embodiments, the outputting of the error message may include outputting different error messages in accordance with a validity rule that is violated by the password entered by the user among a plurality of validity rules related to the regular expression, based on the received error message information.

According to at least one example embodiment, there is provided a password creation method of a computer device including at least one processor, the password creation method including receiving, by the at least one processor, a password creation request transmitted from a terminal of a user under control of a client installed on the terminal of the user; creating, by the at least one processor, a regular expression based on a password creation rule and user information in response to the password creation request; transmitting, by the at least one processor, the regular expression to the terminal of the user; receiving, by the at least one processor from the terminal of the user, a password that is verified based on the regular expression, and that is hashed at the terminal of the user; and registering, by the at least one processor, the hashed password in association with the user.

According to at least one example embodiment, there is provided a non-transitory computer-readable recording medium storing a computer program to execute the method on the computer device.

According to at least one example embodiment, there is provided a computer device including at least one processor configured to execute computer-readable instructions on the computer device, wherein the at least one processor is configured to transmit a password creation request from a user of the computer device to a server, to receive, from the server, a regular expression that is created at the server based on a password creation rule and user information in response to the password creation request, to verify validity of the password entered by the user based on the regular expression, and to hash the password of which the validity is verified and transmit the hashed password to the server.

According to at least one example embodiment, there is provided a computer device including at least one processor configured to execute computer-readable instructions on the computer device, wherein the at least one processor is configured to receive a password creation request transmitted from a terminal of a user under control of a client installed on the terminal of the user, to create a regular expression based on a password creation rule and user information in response to the password creation request, to transmit the regular expression to the terminal of the user, to receive, from the terminal of the user, a password of which validity is verified based on the regular expression, and that is hashed at the terminal of the user, and to register the hashed password in association with the user.

According to some example embodiments, it is possible to provide a method and system for creating a password using a dynamically changeable regular expression.

Further areas of applicability will become apparent from the description provided herein. The description and specific examples in this summary are intended for purposes of illustration only and are not intended to limit the scope of the present disclosure.

### BRIEF DESCRIPTION OF DRAWINGS

FIG. 1 is a diagram illustrating an example of a network environment according to at least one example embodiment;

FIG. 2 is a diagram illustrating an example of a computer device according to at least one example embodiment;

FIG. 3 illustrates an example of a password creation system according to at least one example embodiment;

FIG. 4 is a flowchart illustrating an example of a password creation method according to at least one example embodiment;

FIG. 5 is a flowchart illustrating an example of a password creation method according to at least one example embodiment; and

FIGS. 6 to 11 illustrate examples of a user interface for changing a password according to at least one example embodiment.

### DETAILED DESCRIPTION

One or more example embodiments will be described in detail with reference to the accompanying drawings. Example embodiments, however, may be embodied in various different forms, and should not be construed as being limited to only the illustrated example embodiments. Rather, the illustrated example embodiments are provided as examples so that this disclosure will be thorough and complete, and will fully convey the inventive concepts to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. Also, the term “exemplary” is intended to refer to an example or illustration.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

A hardware device, such as a computer processing device, may run an operating system (OS) and one or more software applications that run on the OS. The computer processing device also may access, store, manipulate, process, and create data in response to execution of the software. For simplicity, one or more example embodiments may be described as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Hereinafter, some example embodiments will be described with reference to the accompanying drawings.

A password creation system according to some example embodiments may be implemented by at least one computer device. For example, a computer program according to an example embodiment may be installed and run on the computer device, and the computer device may perform a password creation method according to example embodiments under control of the computer program. The aforementioned computer program may be stored in a computer-readable recording medium to implement the password creation method in conjunction with the computer device.

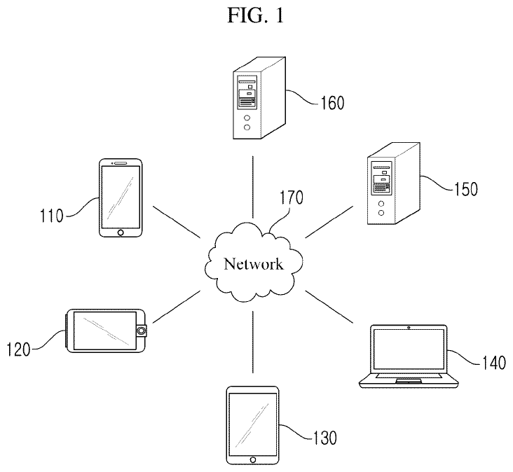

FIG. 1 illustrates an example of a network environment according to at least one example embodiment. Referring to FIG. 1, the network environment may include a plurality of electronic devices 110, 120, 130, and 140, a plurality of servers 150 and 160, and/or a network 170. FIG. 1 is provided as an example only. The number of electronic devices and/or the number of servers is not limited thereto. Also, the network environment of FIG. 1 is provided as one example of environments applicable to the example embodiments and an environment applicable to the example embodiments is not limited to the network environment of FIG. 1.

Each, or one or more, of the plurality of electronic devices 110, 120, 130, and 140 may be a fixed terminal or a mobile terminal that is configured as a computer device. For example, the plurality of electronic devices 110, 120, 130, and 140 may be a smartphone, a mobile phone, a navigation device, a computer, a laptop computer, a digital broadcasting terminal, a personal digital assistant (PDA), a portable multimedia player (PMP), a tablet PC, and the like. For example, although FIG. 1 illustrates a shape of a smartphone as an example of the electronic device 110, the electronic device 110 used herein may refer to one of various types of physical computer devices capable of communicating with other electronic devices 120, 130, and/or 140, and/or the servers 150 and 160 over the network 170 in a wireless or wired communication manner.

The communication scheme is not limited, and may include a near field wireless communication scheme between devices as well as a communication scheme using a communication network (e.g., a mobile communication network, wired Internet, wireless Internet, and a broadcasting network) includable in the network 170. For example, the network 170 may include at least one of network topologies that include a personal area network (PAN), a local area network (LAN), a campus area network (CAN), a metropolitan area network (MAN), a wide area network (WAN), a broadband network (BBN), and/or the Internet. Also, the network 170 may include at least one of network topologies that include a bus network, a star network, a ring network, a mesh network, a star-bus network, a tree or hierarchical network, and the like. However, they are provided as examples only.

Each, or one or more, of the servers 150 and/or 160 may be configured as a computer device or a plurality of computer devices that provides an instruction, a code, a file, content, a service, etc., through communication with the plurality of electronic devices 110, 120, 130, and/or 140 over the network 170. For example, the server 150 may be a system that provides a service to the plurality of electronic devices 110, 120, 130, and/or 140 connected over the network 170.

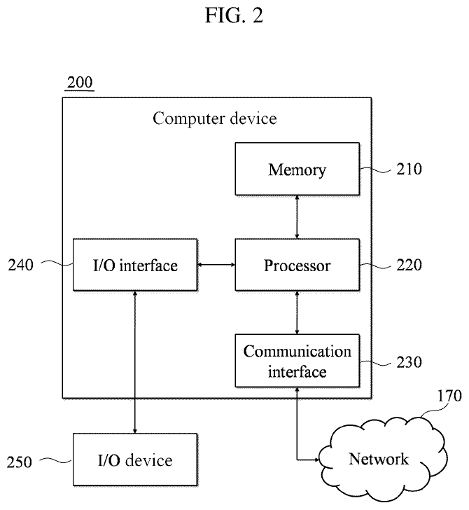

FIG. 2 is a block diagram illustrating an example of a computer device according to at least one example embodiment. Each, or one or more, of the plurality of electronic devices 110, 120, 130, and/or 140 and/or each, or one or more, of the servers 150 and/or 160 may be implemented by a computer device 200 of FIG. 2.

Referring to FIG. 2, the computer device 200 may include a memory 210, a processor 220, a communication interface 230, and/or an input/output (I/O) interface 240. The memory 210 may include a permanent mass storage device, such as a random access memory (RAM), a read only memory (ROM), and/or a disk drive, as a non-transitory computer-readable recording medium. The permanent mass storage device, such as ROM and a disk drive, may be included in the computer device 200 as a permanent storage device separate from the memory 210. An OS and at least one program code may be stored in the memory 210. Such software components may be loaded to the memory 210 from another non-transitory computer-readable recording medium separate from the memory 210. The other non-transitory computer-readable recording medium may include a non-transitory computer-readable recording medium, for example, a floppy drive, a disk, a tape, a DVD/CD-ROM drive, a memory card, etc. According to some example embodiments, software components may be loaded to the memory 210 through the communication interface 230, instead of the non-transitory computer-readable recording medium. For example, the software components may be loaded to the memory 210 of the computer device 200 based on a computer program installed by files received over the network 170.

The processor 220 may be configured to process instructions of a computer program by performing basic arithmetic operations, logic operations, and/or I/O operations. The computer-readable instructions may be provided by the memory 210 and/or the communication interface 230 to the processor 220. For example, the processor 220 may be configured to execute received instructions in response to a program code stored in a storage device, such as the memory 210.

The communication interface 230 may provide a function for communication between the computer device 200 and another apparatus, for example, the aforementioned storage devices, over the network 170. For example, the processor 220 of the computer device 200 may forward a request and/or an instruction created based on a program code stored in the storage device such as the memory 210, data, and/or a file, to other apparatuses over the network 170 under control of the communication interface 230. Inversely, a signal, an instruction, data, a file, etc., from another apparatus may be received at the computer device 200 through the communication interface 230 of the computer device 200. A signal, an instruction, data, etc., received through the communication interface 230 may be forwarded to the processor 220 and/or the memory 210, and/or a file, etc., may be stored in a storage medium, for example, the permanent storage device, further includable in the computer device 200.

The I/O interface 240 may be a device used for interfacing with an I/O device 250. For example, an input device may include a device, such as a microphone, a keyboard, a mouse, etc., and an output device may include a device, such as a display, a speaker, etc. As another example, the I/O interface 240 may be a device for interfacing with an apparatus in which an input function and an output function are integrated into a single function, such as a touchscreen. At least one of the I/O device 250 may be configured as a single apparatus with the computer device 200. For example, it may be implemented in a form in which a touchscreen, a microphone, a speaker, and the like are included in the computer device 200, such as a smartphone.

According to some example embodiments, the computer device 200 may include a greater or smaller number of components than the number of components shown in FIG. 2. However, there is no need to clearly illustrate most conventional components. For example, the computer device 200 may be configured to include at least a portion of the I/O device 250 or may further include other components, such as a transceiver and a database.

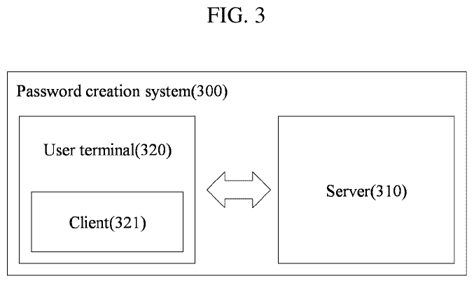

FIG. 3 illustrates an example of a password creation system according to at least one example embodiment. A password creation system 300 according to example embodiments of FIG. 3 may include a server 310 configured to provide a web-based service and/or a user terminal 320 configured to be provided with the web-based service through access to the server 310. Although there may be a plurality of users that desire to be provided with the web-based service through access to the server 310 and a plurality of terminals used by the plurality of users, they are omitted in FIG. 3. Each, or one or more, of the user terminal 320 and/or the server 310 may be implemented by at least one computer device 200. A client 321 linked with the web-based service provided from the server 310 may be installed and run on the user terminal 320, and the client 321 may control the user terminal 320 to access the server 310 and to be provided with the web-based service.

The server 310 may basically provide a login service to identify and authenticate a user, and in addition thereto, may also provide various services. The user may register an ID and a password to the server 310 through the login service, and the server 310 may identify and authenticate the user that desires to use the web-based service provided from the server 310 using the registered ID and password.

The user needs to create a password when the user registers an initial password and/or changes the registered password. For example, the server 310 may dynamically create a regular expression using a preset, or alternately given, password creation rule and user information in response to a password creation request from the client 321 and may provide the regular expression to the client 321, and the client 321 may verify validity of the password entered by the user based on the regular expression provided from the server 310.

For example, the server 310 may create a regular expression that includes a new password creation rule created by dynamically changing the password creation rule based on the user information. for example, the password creation rule may include, for example, some of various rules, such as the number of characters that the password needs to include, whether the password needs to include an uppercase letter, whether the password needs to include a lowercase letter, whether the password needs to include a number, whether the password needs to include a symbol, the number of numbers the password needs to include, and/or the number of symbols the password needs to include. For example, instead of requiring the same password creation rule, the server 310 may encourage all users to create passwords in accordance with the regular expression that includes the new password creation rule dynamically changed from the password creation rule based on the user information.

According to some example embodiments, the user information may include at least a portion of information of various items collectable for the user, such as a name of the user, a telephone number of the user, an address of the user, an e-mail address of the user, a type or a version of the user terminal 320, a current location of the user, and/or profile information of the user's social network service. For example, at least a portion of the user information used by the server 310 to create the regular expression may include information that is not stored in the user terminal 320, not managed by the client 321, and/or information stored only in the server 310. For example, a portion of various items of user information described above may not need to be stored in the user terminal 320, or may not need to be managed by the client 321. In this case, the server 310 may create the regular expression that includes the new password creation rule using user information in which information manageable only by the server 310 is included. For example, the server 310 may extract user-related information, such as the user's birthday or last four digits of the user's telephone number, from the user information, and may create the regular expression using the extracted user-related information. In detail, for example, the server 310 may verify that the user's birthday is 1/11 and may accordingly create the regular expression that ‘111’ cannot be included in the password, or may verify that the last four digits of the user's telephone number are ‘9876’ and may accordingly create the regular expression that ‘9876’ cannot be included in the password.

This regular expression may be differently created for each of at least two users based on the user information, and may be differently created even for the same user in response to a change in the user information. Therefore, although the preset, or alternately given, same password creation rule is present in the server 310, a different password creation rule may be applied for each user or each version of the user information, so it is possible to use passwords created using various rules even in the same service.

The server 310 may create at least one error message information for the password creation rule or the regular expression based on the password creation rule or the regular expression, respectively, and may transmit the at least one error message information to the user terminal 320 with the password creation rule or the regular expression.

The client 321 may induce the user to create a password in accordance with the new password creation rule by providing information on this regular expression to the user, and may verify validity of the password entered by the user by verifying whether the password entered by the user is a password suitable for the regular expression (new password creation rule). According to some example embodiments, when the password entered by the user is verified as a password unsuitable for the regular expression, an error message may be displayed depending on which validity rule is violated. For example, the error message may be determined depending on which validity rule is applied to the corresponding user. Therefore, although different users enter the same password as a new password, different validity rules may be applied depending on users and different error messages may be displayed. When user 1 and user 2 enter the same password, “0111abc!,” an error message saying, “You cannot use the same number consecutively” may be displayed for user 1 and an error message saying “You cannot use a password that includes a birthday” may be displayed for user 2. When the validity of the password entered by the user is verified, the client 321 may encrypt the password of which the validity is verified and may transmit the same to the server 310. As another example, the client 321 may hash the password of which the validity is verified and may transmit the same to the server 310 For example, the client 321 may control the user terminal 320 to perform the aforementioned operations of the client 321. The server 310 may receive the encrypted and/or hashed password from the client 321, and may register the received password in association with the user. If the password creation request is to change the password and a preregistered password is present, the server 310 may change the preregistered password with the newly received password.

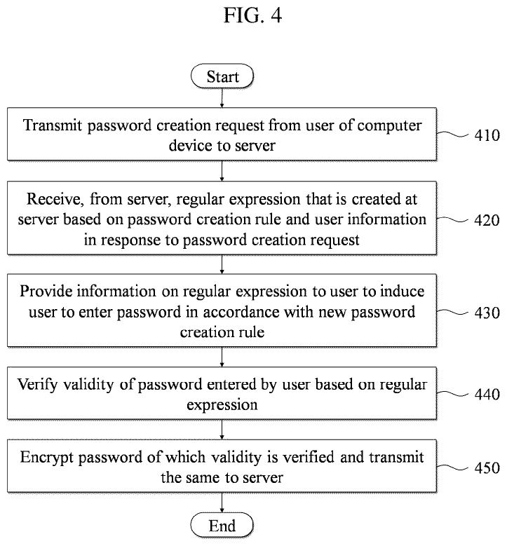

FIG. 4 is a flowchart illustrating an example of a password creation method according to at least one example embodiment. The password creation method according to some example embodiments may be performed by at least one computer device 200 that implements the user terminal 320. For example, the processor 220 of the computer device 200 may be implemented to execute a control instruction according to a code of at least one computer program or a code of an operating system included in the memory 210. For example, the processor 220 may control the computer device 200 to perform operations 410 to 450 included in the method of FIG. 4 in response to a control instruction provided from a code stored in the computer device 200.

In operation 410, the computer device 200 may transmit a password creation request from the user of the computer device 200 to a server. For example, the server may correspond to the server 310 described above with reference to FIG. 3. For example, the computer device 200 may transmit the password creation request created in response to an input from the user to the server under control of a computer program that is installed and runs on the computer device 200 as the client 321. This password creation request may occur when the user initially attempts to sign up for a service provided from the server, and/or when the user desires to change a password.

In operation 420, the computer device 200 may receive, from the server, a regular expression that is created at the server based on a password creation rule and/or user information in response to the password creation request. As described above, the server may dynamically change the password creation rule created in advance in response to the password creation request based on the user information, may create a regular expression that includes a new password creation rule, and/or may transmit the created regular expression to the client. For example, the regular expression may be differently created for each, or one or more, of at least two users based on the user information, and/or may be differently created even for the same user in response to a change in the user information. According to some example embodiments, in operation 420, the computer device 200 may receive, from the server, the regular expression that is dynamically created at the server based on at least user information in response to the password creation request.

According to some example embodiments, at least a portion of the user information may include information that is not stored in the computer device 200, not managed by a computer program as the client, and/or stored only in the server.

According to some example embodiments, the regular expression may be determined based on a user activity in a social network service linked with the client 321. For example, if access to the social network service is greater than or equal to a predetermined, or alternately given, frequency or more, the regular expression may be created to include a password with fewer digits compared to a case in which the access is less than the predetermined, or alternately given, frequency.

In operation 430, the computer device 200 may provide information on the regular expression to the user to induce the user to enter a password in accordance with the new password creation rule. For example, the computer device 200 may display information on the regular expression through a display included in the computer device 200.

In operation 440, the computer device 200 may verify validity of the password entered by the user based on the regular expression. For example, the computer device 200 may determine whether the password entered by the user is suitable for the new password creation rule included in the regular expression. That is, creation of the regular expression may be performed at the server, and validity verification, that is, validation of the password based on this regular expression may be performed at the client.

According to some example embodiments, when receiving the regular expression from the server in operation 420, the computer device 200 may further receive, from the server, at least one error message information that is created based on the password creation rule and/or the regular expression. This error message information may be used to output an appropriate error message when the password entered by the user violates the validity rule according to the validity verification at the client. That is, when the password entered by the user violates the regular expression in operation 440, the computer device 200 may output an error message based on the received error message information. For example, the computer device 200 may output different error messages in accordance with a validity rule the password entered by the user violates among a plurality of validity rules related to the regular expression, based on the received error message information.

In operation 450, the computer device 200 may encrypt the password of which the validity is verified and may transmit the same to the server. In this case, the server may register the encrypted password in association with the user. That is, since the server dynamically creates the password creation rule and the client verifies the validity of the password and provides the encrypted password to the server, it is possible to register a password that meets the password creation rule dynamically created by the server without exposing the password to the server. According to some example embodiments, in operation 450, the computer device 200 may hash the password of which the validity is verified and may transmit the same to the server. In this case, the server may register the hashed password in association with the user. That is, since the server dynamically creates the password creation rule, and the client verifies validity of the password and provides the hashed password to the server, it is possible to register a password suitable for the password creation rule dynamically created by the server without exposing the password to the server.

Therefore, according to some example embodiments, a personalized password creation rule for the user may provide increased security by, for example, being more difficult for a hacker to guess. The password with the increased security may further be registered by the server without exposing the password to the server, and thus adding an additional layer of security.

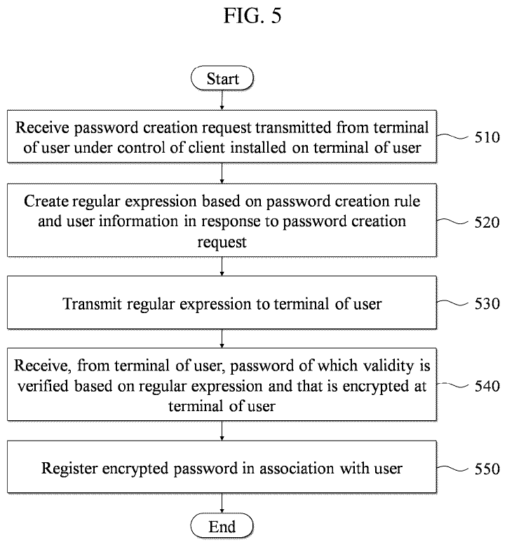

FIG. 5 is a flowchart illustrating an example of a password creation method according to at least one example embodiment. The password creation method according to some example embodiments may be performed by at least one computer device 200 that implements the server 310. For example, the processor 220 of the computer device 200 may be implemented to execute a control instruction according to a code of at least one computer program and/or a code of an operating system included in the memory 210. For example, the processor 220 may control the computer device 200 to perform operations 510 to 550 included in the method of FIG. 5 in response to a control instruction provided from a code stored in the computer device 200.

In operation 510, the computer device 200 may receive a password creation request transmitted from a terminal of a user under control of a client installed on the terminal of the user. For example, the terminal of the user and the client may correspond to the user terminal 320 and the client 321 described above with reference to FIG. 3, respectively. As described above, the password creation request may occur when the user initially attempts to sign up a service provided from the server, and/or when the desires to change a password.

In operation 520, the computer device 200 may create a regular expression based on a password creation rule and user information in response to the password creation request. For example, the computer device 200 may create the regular expression including a new password creation rule that is created by dynamically changing the password creation rule based on the user information. As described above, the regular expression may be differently created for each, or one or more, of at least two users based on the user information, and/or may be differently created even for the same user in response to a change in the user information. According to some example embodiments, in operation 520, the computer device 200 may receive, from the server, the regular expression that is dynamically created based on at least user information in response to the password creation request.

According to some example embodiments, at least a portion of the user information may include information that is not stored in the terminal of the user, not managed by the client installed and running on the terminal of the user, and/or stored only in the computer device 200 that implements the server 310.

According to some example embodiments, the regular expression may be determined based on a user activity in a social network service linked with the server 310. For example, if access to the social network service is greater than or equal to a predetermined, or alternately given, frequency, a less strict regular expression may be created compared to a case in which the access is less than the predetermined, or alternately given, frequency. The less strict regular expression may include a regular expression that requires a password with fewer digits and/or a regular expression that includes fewer conditions, and a stricter regular expression may include a regular expression that requires a password with more digits and/or a regular expression that includes more conditions.

In operation 530, the computer device 200 may transmit the regular expression to the terminal of the user. In this case, the terminal of the user may verify validity of a password entered by the user based on the regular expression. For example, the terminal of the user may determine whether the password entered by the user is suitable for the new password creation rule included in the regular expression under control of the client. For example, the terminal of the user may encrypt and/or hash the password of which the validity is verified and may transmit the same to the server.

In operation 540, the computer device 200 may receive, from the terminal of the user, the password of which the validity is verified based on the regular expression and that is encrypted or hashed at the terminal of the user.

In operation 550, the computer device 200 may register the encrypted and/or hashed password in association with the user. As such, since the server dynamically creates the password creation rule and the client verifies the validity of the password and provides the encrypted password to the server, it is possible to register a password that meets the password creation rule dynamically created by the server without exposing the password to the server.

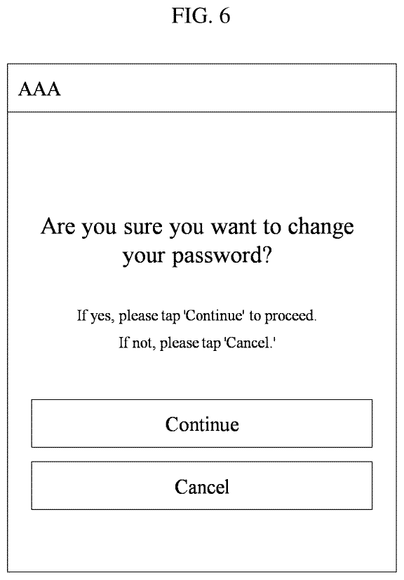

FIGS. 6 to 11 illustrate examples of a user interface for changing a password according to at least one example embodiment.

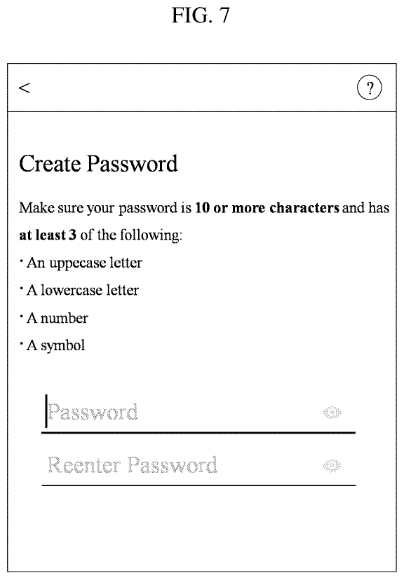

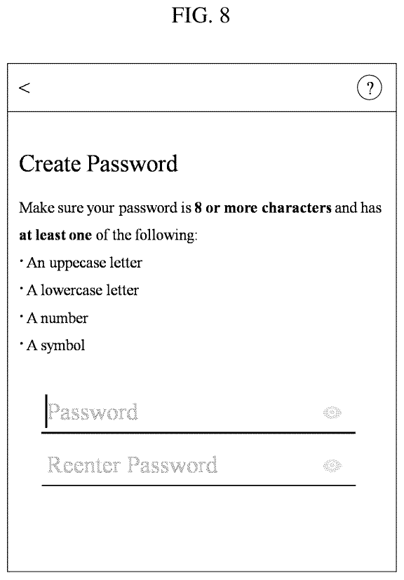

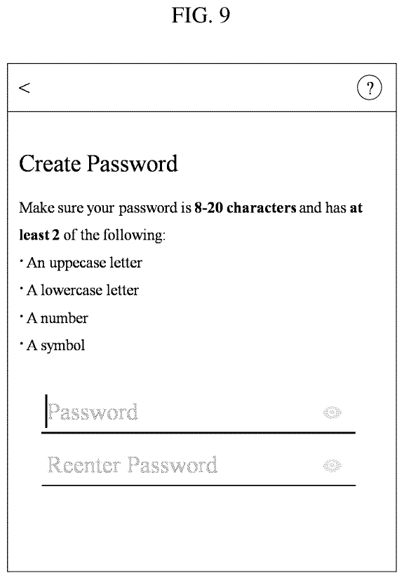

FIG. 6 illustrates an example of a screen for verifying the intent of a user when the user requests to change a password. When the user selects a ‘Continue’ button, a screen that allows the user to enter a new password may be provided as shown in FIGS. 7, 8, and 9. For example, FIGS. 7, 8, and 9 represent examples in which different regular expressions are displayed, respectively. For example, FIG. 7 represents an example of a regular expression that requests the user to enter a password including 10 or more characters and including at least three of an uppercase letter, a lowercase letter, a number, and a symbol. FIG. 8 represents an example of a regular expression that requests the user to enter a password including 8 or more characters and including at least one of an uppercase letter, a lowercase letter, a number, and a symbol. FIG. 9 represents an example of a regular expression that requests the user to enter a password including 8 to 20 characters and including at least two of an uppercase letter, a lowercase letter, a number, and a symbol. The example embodiments of FIGS. 7 to 9 represent examples of a regular expression that applies a different value to each item in a state in which items of a password creation rule are fixed. Depending on example embodiments, items of the password creation rule may be changed. For example, the example embodiments of FIG. 7 require a stricter password creation rule compared to the example embodiments of FIG. 8. As such, based on user information, it is possible to provide a stricter password creation rule to some users and to provide a relatively less strict password creation rule to other users. For example, if the user information is changed within a predetermined, or alternately given, period of time from a point in time at which the password is created or changed, a stricter password creation rule may be required.

Therefore, according to some example embodiments, a security of a password for some users who may benefit from a stronger password may be required to be stricter, while a security of a password for some users who may not benefit from as strong of a password may not be required to be as strict. Thus, according to example embodiments, rules for password generation requirements may be dynamically determined according to individual needs on a per user basis. Thus, according to some example embodiments, a user may use a password generated according to example embodiments to more securely log in to and/or use a service. For example, information transmitted and/or stored by the service may be more securely transmitted and/or stored. For example, a more secure connection may be established between the user terminal 320 and the server 310 when logged in to the service using a password generated according to example embodiments.

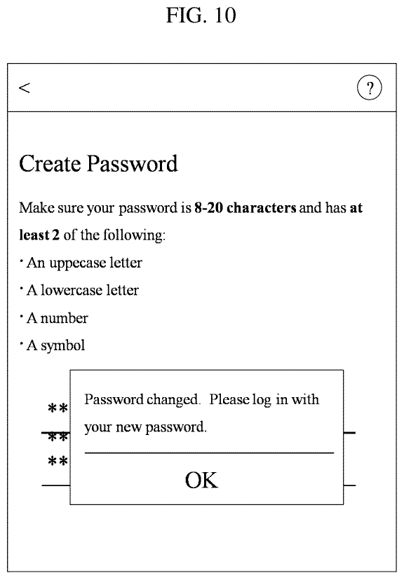

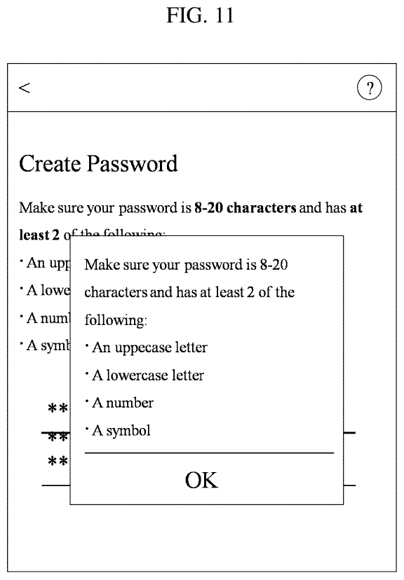

According to some example embodiments, dynamic creation according to user information of the password creation rule may be performed through the server, and validity verification of the password according thereto may be performed by a client. For example, FIG. 10 shows an example of a screen on which the client notifies the user that a password is changed as a valid password is entered, and FIG. 11 shows an example of a screen on which the client notifies the user again of the password creation rule as an invalid password is entered. The client may encrypt or hash the password of which the validity is verified and may transmit the same to the server and accordingly, may create the password in accordance with the password creation rule that is dynamically created by the server without exposing the password to the server, and may register the created password to the server. Also, the client may provide an appropriate error message to the password entered by the user.

As described above, according to some example embodiments, it is possible to provide a method and system for creating a password using a dynamically changeable regular expression.

One or more of the elements disclosed above may include or be implemented in one or more processing circuitries such as hardware including logic circuits; a hardware/software combination such as a processor executing software; or a combination thereof. For example, the processing circuitries more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

The systems or the apparatuses described above may be implemented using hardware components, software components, and/or combination thereof. For example, the apparatuses and components described herein may be implemented using one or more general-purpose or special purpose computers, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. A processing device may run an operating system (OS) and one or more software applications that run on the OS. The processing device also may access, store, manipulate, process, and create data in response to execution of the software. For simplicity, the description of the processing device is used as singular; however, one skilled in the art will be appreciated that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied in any type of machine, component, physical equipment, virtual equipment, a computer storage medium or device, or in a propagated signal wave capable of providing instructions or data to or being interpreted by the processing device. The software also may be distributed over network coupled computer devices so that the software is stored and executed in a distributed fashion. The software and data may be stored by one or more computer readable storage mediums.

The methods according to some example embodiments may be configured in a form of program instructions performed through various computer methods and recorded in non-transitory computer-readable media. The media may include, alone or in combination with program instructions, data files, data structures, and the like. For example, the media may continuously store computer-executable programs or may temporarily store the same for execution or download. Also, the media may be various types of recording devices or storage devices in a form in which one or a plurality of hardware components are combined. Without being limited to media directly connected to a computer system, the media may be distributed over the network. Examples of the media may include magnetic media such as hard disks, floppy disks, and magnetic tapes; optical media such as CD-ROM and DVDs; magneto-optical media such as floptical disks; and hardware devices that are specially configured to store and perform program instructions, such as ROM, RAM, flash memory, and the like. Examples of other media may include recording media and storage media managed by an app store that distributes applications or a site, a server, and the like that supplies and distributes other various types of software. Examples of the program instructions include an advanced language code that may be executed by a computer using an interpreter as well as a machine language code as produced by a compiler.

While this disclosure includes specific example embodiments, it will be apparent to one of ordinary skill in the art that various alterations and modifications in form and details may be made in these example embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents. Therefore, other implementations, other example embodiments, and equivalents are within the scope of the following claims.

What is claimed is:

1. A non-transitory computer-readable recording medium storing instructions to execute a password creation method on a computer device in conjunction with the computer device, wherein the password creation method comprises:
transmitting a password creation request from a user of the computer device to a server;
receiving, from the server, a regular expression that is created at the server based on a password creation rule and user information in response to the password creation request;
verifying validity of a password entered by the user based on the regular expression; and
hashing the password of which the validity is verified and transmitting the hashed password to the server.

2. The non-transitory computer-readable recording medium of claim 1, wherein the regular expression includes the password creation rule that is determined based on the user information or user activity in an application associated with the computer device.

3. The non-transitory computer-readable recording medium of claim 1, wherein the password creation method further comprises providing the user with information on the regular expression to induce the user to enter a new password in accordance with the password creation rule.

4. The non-transitory computer-readable recording medium of claim 1, wherein the regular expression is determined based on the user information, and
wherein the regular expression is different from a regular expression created for another user.

5. The non-transitory computer-readable recording medium of claim 1, wherein the regular expression is differently created according to a change in the user information.

6. The non-transitory computer-readable recording medium of claim 1, wherein at least a portion of the user information includes at least one of
information that is not stored in the computer device, information that is not managed by a computer program, or
information that is stored only in the server.

7. The non-transitory computer-readable recording medium of claim 1, wherein the receiving of the regular expression from the server comprises further receiving, from the server, at least one error message information that is created based on the password creation rule or the regular expression, and
the verifying of the validity of the password comprises outputting an error message based on the at least one error message information in response to the password entered by the user violating the regular expression.

8. The non-transitory computer-readable recording medium of claim 7, wherein the outputting of the error message comprises outputting different error messages in accordance with a validity rule that is violated by the password entered by the user among a plurality of validity rules related to the regular expression, based on the at least one error message information.

9. A password creation method of a computer device comprising at least one processor, the password creation method comprising:
transmitting, by the at least one processor, a password creation request from a user of the computer device to a server;
receiving, by the at least one processor from the server, a regular expression that is created at the server based on a password creation rule and user information in response to the password creation request;
verifying, by the at least one processor, validity of the password entered by the user based on the regular expression; and
hashing, by the at least one processor, the password of which the validity is verified and transmitting the hashed password to the server.

10. The password creation method of claim 9, wherein the regular expression includes the password creation rule that is determined based on the user information or user activity in an application associated with the computer device.

11. The password creation method of claim 9, wherein the regular expression is determined based on the user information, and
wherein the regular expression is different from a regular expression created for another user.

12. The password creation method of claim 9, wherein the regular expression is differently created according to a change in the user information.

13. The password creation method of claim 9, wherein at least a portion of the user information includes at least one of
information that is not stored in the computer device,
information that is not managed by a computer program, or
information stored only in the server.

14. A computer device comprising:
at least one processor configured to execute computer-readable instructions on the computer device,
wherein the at least one processor is configured to,
receive a password creation request transmitted from a terminal of a user under control of a client installed on the terminal of the user,
create a regular expression based on a password creation rule and user information in response to the password creation request,
transmit the regular expression to the terminal of the user,
receive, from the terminal of the user, a password that is verified based on the regular expression, and that is hashed at the terminal of the user, and
register the hashed password in association with the user.

15. The computer device of claim 14, wherein, the at least one processor is configured to create the regular expression including the password creation rule that is determined based on the user information or user activity in an application associated with the terminal of the user.

16. The computer device of claim 14, wherein the at least one processor is configured to create the regular expression differently for each of at least two users by the user information.

17. The computer device of claim 14, wherein the at least one processor is configured to create the regular expression differently according to a change in the user information.

18. The computer device of claim 14, wherein at least a portion of the user information includes at least one of
information that is not stored in the terminal of the user,
information that is not managed by the client, or
information stored only in the computer device.

19. The computer device of claim 14, wherein the at least one processor is configured to,
create at least one error message information based on the password creation rule or the regular expression,
transmit the at least one error message information to the terminal of the user, and
output an error message based on the error message information in response to the password entered by the user to the terminal of the user violating the regular expression.
